(19) United States
(12) Patent Application Publication
(10) Pub. No.: US 2006/0070001 A1
(43) Pub. Date: Mar. 30, 2006

(54) Computer assisted presentation authoring for multimedia venues

(75) Inventors: Qiong Liu, Milpitas, CA (US); Donald G. Kimber, Foster City, CA (US); Fan Zhao, Mountain View, CA (US); Surapong Lertsithichai, Bangkok (TH); Jonathan T. Foote, Menlo Park, CA (US)

Correspondence Address: FLIESLER MEYER, LLP, FOUR EMBARCADERO CENTER, SUITE 400, SAN FRANCISCO, CA, 94111, US

(73) Assignee: FUJI XEROX CO., LTD., Tokyo (JP)

(21) Appl. No.: 10/952,976

(22) Filed: Sep. 29, 2004

(51) Int. Cl. G06F 17/00

(52) U.S. Cl. 715/732

(57) ABSTRACT

A system and method for optimizing the visual fidelity of a presentation for a plurality of audience members and a plurality of display devices, comprising: modeling the quality of view available to the plurality of audience members based on: one or more properties of the display devices, a distribution of the display devices, a distribution of the plurality of audience members, and the visual presentation wherein the visual presentation comprises one or more h-slides; and determining an optimal mapping for the one or more h-slides to the plurality of display devices based on the modeling.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The present pertains to computer assisted organization of presentations for multimedia venues.

### BACKGROUND

Many meeting environments are now provided with multimedia devices, such as plasma displays and surrounding speakers, to enhance presentation quality. However, with typical presentation authoring tools, meeting participants do not benefit from devices other than a single display and a stereo channel. The price decrease of high-end multimedia devices encourages presenters to enhance their presentations by using more such devices. For example, a presenter can use a primary display to present text, while using another display to show a supporting figure or video.

Many popular authoring tools are suited for creating units of media (e.g. slides) for rendering on a single display device, but provide no support for authoring and presenting across multiple devices. This hinders presenters from using additional devices for presentation enhancement or tele-presentation. What is needed is a presentation authoring and replaying tool that facilitates presentation preparation and playback for multiple multimedia devices.

### BRIEF DESCRIPTION OF THE DRAWINGS

FIG. 2 illustrates a graphical user interface in accordance to various embodiments.

FIG. 3a illustrates playback in an augmented reality environment in accordance to various embodiments.

FIG. 3b illustrates playback in a virtual environment in accordance to various embodiments.

FIG. 4 illustrates a system in accordance to various embodiments.

FIG. 5 is a flow chart illustrating computer authoring in accordance to various embodiments.

FIG. 6a illustrates a visual signal model for an audience member's view of a signal in accordance to various embodiments.

FIG. 6b illustrates the display scan direction (φ₁, θ₁) in accordance to various embodiments.

FIG. 7 is a flow chart illustrating selection of a media device for an h-slide in accordance to various embodiments.

FIG. 8 illustrates an exemplary conference room.

FIG. 9 illustrates exemplary α and β variations for an audience member sitting at location 1 in FIG. 8.

FIG. 10a illustrates three h-slides used in an exemplary presentation.

FIG. 10b illustrates computed distortions of various slide arrangements for an audience member at location 1.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

Embodiments of this present disclosure are complementary to tools used for authoring specific media (e.g., Microsoft® PowerPoint) and can be used to organize media units prepared for single media devices into a synchronous, multi-media presentation wherein different media devices can present different media. A media device is device capable of presenting or capturing text, image and/or sound information, or controlling a device. By way of a non-limiting illustration, a media device can include a video display (e.g., plasma monitor, liquid crystal display, television), a video camera, a microphone, a digitizer, speakers, a printer, a room light, and any other suitable device. It will be appreciated by those of skill in the art that many more media devices are possible, both presently known and yet to be developed, and are fully within the scope and spirit of the present disclosure. In addition, embodiments of the present disclosure support multiple configuration of media devices.

A venue is a setting in which a presentation occurs. It may be a single room, or distributed as in the case of presentations teleconferenced across multiple locations. A venue model is an image/video of a venue or a 2D/3D graphical layout of a venue. A device portal is a graphical region of the venue model designating a media device. FIG. 1 is an illustration of a venue model 100 having device portals 102, 104, and 106 in accordance to various embodiments. In one embodiment, device portals can be made visually distinct or highlighted in some manner (e.g., with a bounding box).

In one embodiment, a device portal can have associated with it one or more of the following properties: name, media device type and related characteristics (e.g., display resolution, frame rate, etc.), computer host, connection port, location and size. Device portals can be created, modified and deleted through a user interface. By way of a non-limiting example, a user interface can include one or more of the following: 1) a graphical user interface (GUI) rendered on a display device or projected onto a user's retina; 2) an ability to respond to sounds and/or voice commands; 3) an ability to respond to input from a remote control device (e.g., a cellular telephone, a PDA, or other suitable remote control); 4) an ability to respond to gestures (e.g., facial and otherwise); 5) an ability to respond to commands from a process on the same or another computing device; and 6) an ability to respond to input from a computer mouse and/or keyboard. This disclosure is not limited to any particular user interface. Those of skill in the art will recognize that many other user interfaces are possible and fully within the scope and spirit of this disclosure.

In one embodiment, a user can define a device portal for a media device by pressing down a mouse button and dragging the mouse over a region of the venue model corresponding to the location of the media device. When the mouse button is released, a bounding box of the mouse path is created. The location and size properties of the device portal are defined according to location and size of the bounding box. After the bounding box is specified, a dialog box can be presented to the user for specification of the portal's other properties. In one embodiment, a user can press the right mouse button while the mouse is positioned over a device portal in order to change its properties. The system also supports removal of a portal with similar operations. In one embodiment, portal definitions can be saved in a template file with a venue model. For each venue, the template file only needs to be created once. After which it can be exploited by multiple users for creating multimedia presentations.

In one embodiment, an Environment Picking Image Canvas (EPIC) is an interactive tool for authoring and running multimedia presentations. In aspects of these embodiments, EPIC includes a user interface depicting a multimedia presentation environment that allows a user to easily refer to media devices for authoring a presentation. EPIC also can provide computer-assisted authoring functionality which automatically assigns media to various devices according to users' guidelines and/or venue configurations. Moreover, EPIC's online content manipulation functionality allows users to extemporaneously modify a presentation. For example, a user may add additional slides or annotate existing slides in response to audience questions.

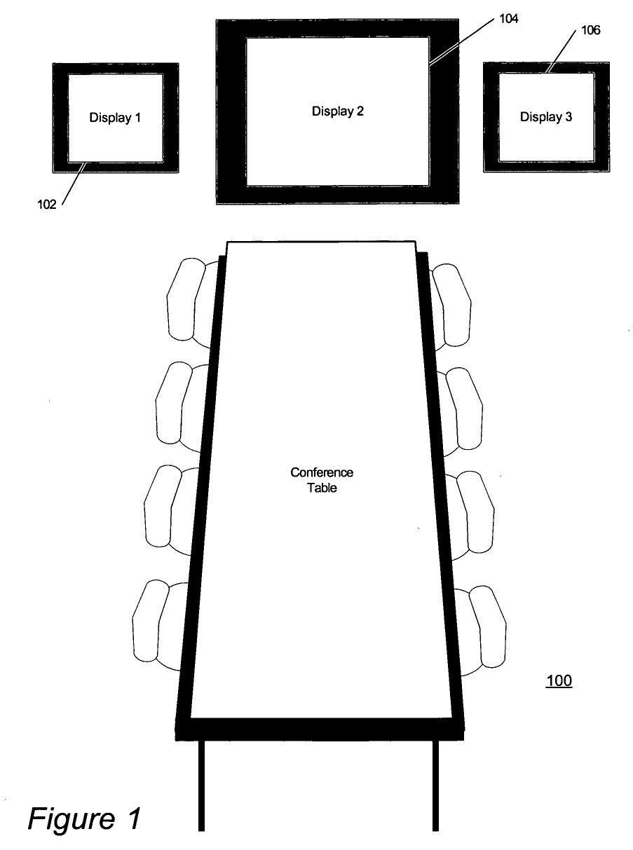

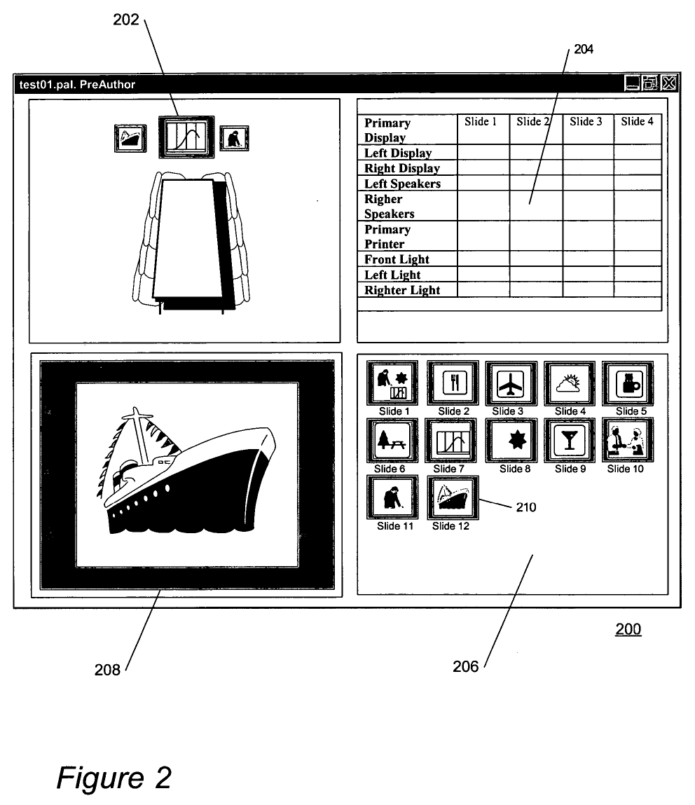

FIG. 2 illustrates an EPIC graphical user interface 200 in accordance to various embodiments. EPIC includes a venue canvas 202 for display and manipulation of a venue model and device portals, an h-slide pane 206 for displaying available h-slides (e.g., as thumbnails), a zoom pane 208 for checking details of a user's selection, and a device-state table (DST) 204 pane for revealing which hyper-slide is rendered on each device at each state in a presentation. A hyper-slide (“h-slide”) is the basic presentation unit of EPIC. It can be an input source, a control action, or an object that can be ‘rendered’ by a device. Rendering can include displaying image(s) and/or sounds. By way of illustration, an h-slide can be a regular PowerPoint slide, an image, a video clip, an audio segment, a webpage, streaming video (with or without sound), streaming audio, or even a light control command (on/off/dim). In this illustration, h-slide 210 has been selected by the user, so its contents are shown in the zoom pane.

In one embodiment, the DST pane allows the user to see and to specify which h-slides are rendered on which device at each state of a presentation. The DST is also useful for revealing h-slides' relations on a display. Each row of DST corresponds to an available channel, while each column of DST corresponds to an indexed state, which is used to synchronize h-slides' playbacks on various devices. A channel is an abstract device to which h-slides can be associated, which can be mapped to one or more device portals. For example, a primary-display channel is typically mapped to the most prominent display(s) in a venue. A notes-channel may “broadcast” some h-slides to devices such as audience members' laptop displays. A video channel may be associated with a visual display and a loud speaker. To deal with various devices via the user interface, a device portal can be defined for every controllable device in the venue canvas.

In one embodiment and by way of illustration, EPIC can also be used to configure media devices in multiple meeting rooms. At DST state 0 in a multimedia presentation, we may let the system connect video camera 1 in meeting room A to display 1 in meeting room B, and connect video camera 1 in meeting room B to display 1 in room A. Similarly, we can set up microphone-speaker connections, camera poses, projector lifts, motorized projection screens, room partition switches, and many other device actions. This kind of configuration only needs to be created once for every teleconference environment. With all these settings organized in the DST, the system will set up all devices for us when we a user runs a presentation.

In one embodiment, EPIC supports mouse manipulations of h-slides in various ways within the GUI. By way of illustration, a user can drag an h-slide thumbnail onto a portal to indicate the h-slide should be displayed on the device associated with that portal. After the drag and drop action, the h-slide will appear in the DST based on that device and the current state. In addition, h-slides located in various DST cells are also movable for authoring convenience. The user may also double-click on a h-slide thumbnail to launch a tool for editing that type of h-slide (e.g. PowerPoint for a PPT slide).

Techniques for dragging and dropping information onto devices in a conference setting are discussed in the following co-pending application which is hereby incorporated by reference in its entirety: U.S. patent application Ser. No. 10/629,403 entitled A VIDEO ENABLED TELE-PRESENCE CONTROL HOST, by Qiong Liu et al., filed Jul. 28, 2003. (Attorney Docket No. FXPL-1063US0.)

During a preview or an actual presentation, EPIC controls the mapping of h-slides to devices according to the DST. When a slide change is triggered, EPIC can synchronously change the h-slide rendered for each media device. The presenter may also make ad-hoc changes by dragging h-slides to device portals. In one embodiment this has the effect of inserting new states in the DST. For example, a user may drag an h-slide from a computer desktop metaphor or from an h-slide pane to a device portal in the venue pane. As a result, the DST will be modified dynamically to cause the h-slide to be displayed on the device corresponding to the device portal at the current state in the presentation. The resulting DST can be saved for a future presentation.

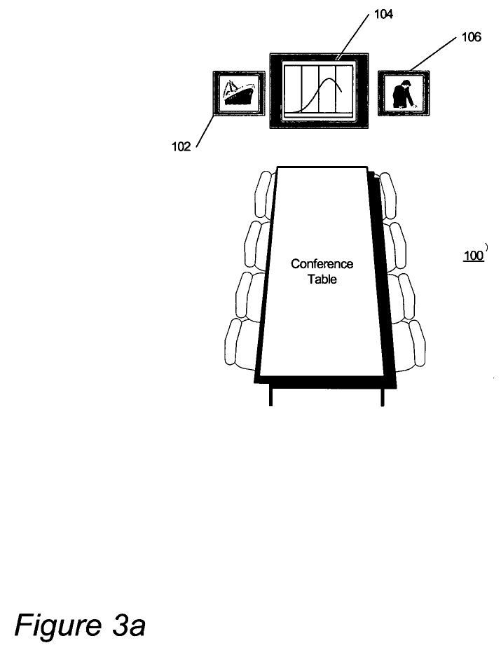

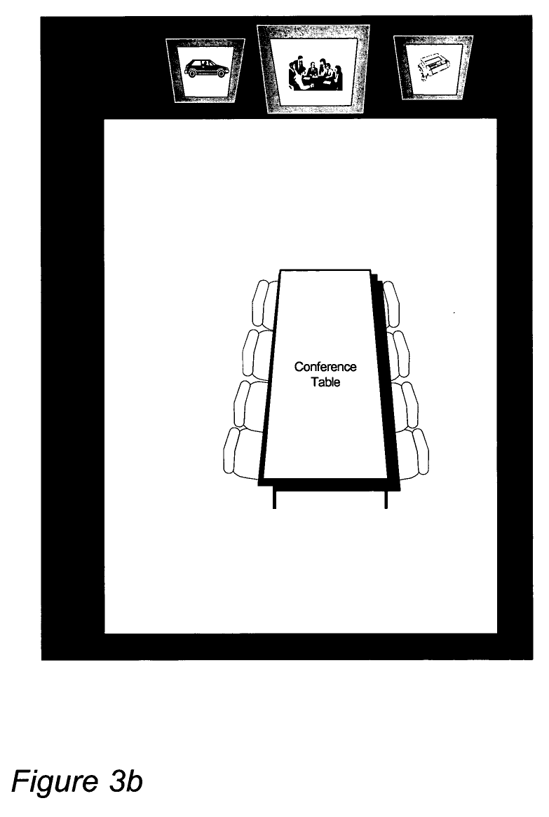

In one embodiment, EPIC supports previewing a presentation in an augmented reality environment, a virtual environment, or the real environment. FIG. 3a is an illustration of playback in an augmented reality environment in accordance to various embodiments. Pictures of h-slides are rendered over regions of a venue canvas, indicating such an image would be displayed with the underlying device. FIG. 3b is an illustration of playback in a virtual environment in accordance to various embodiments. In one embodiment, this feature can use Virtual Reality Markup Language (VRML) to create a 3-D venue model in the venue canvas. The presentation is played back in the 3-D model, which enables the user to change their viewpoint to observe the presentation from different audience perspectives. In addition, the user can zoom in and out of the venue model to examine details of a presentation or gain perspective.

The user can view the playback in the real environment. In this case, the venue canvas can show live video of the venue as the presentation is played. During playback, EPIC sends out synchronized commands to multiple networked devices. Unlike a classical presentation tool that responds to a key-press with a slide advance on one display, EPIC responds to a key-press with a set of synchronized media rendering commands for all involved devices. Presentation venues may be distributed across multiple locations, as for teleconferenced presentations. The EPIC environmental pane can show live video from a remote conference room, and a user can monitor details of the remote location with the zoom pane. This feature is useful for giving a presentation in a remote site.

In various embodiments, the EPIC user interface includes tool bars for media device definition, file manipulation, presentation control and DST manipulation. The media device definition tool bar includes buttons for each type of media device (e.g., video display, speaker, light and printer) and can be used for defining portals. The file manipulation tool bar can be used for opening and saving presentations, printing presentations, and other file operations. The presentation control toolbar is used for starting and stopping a presentation. Finally, the DST manipulation toolbar allows operations to be performed on the DST, such as inserting, deleting and modifying presentation states.

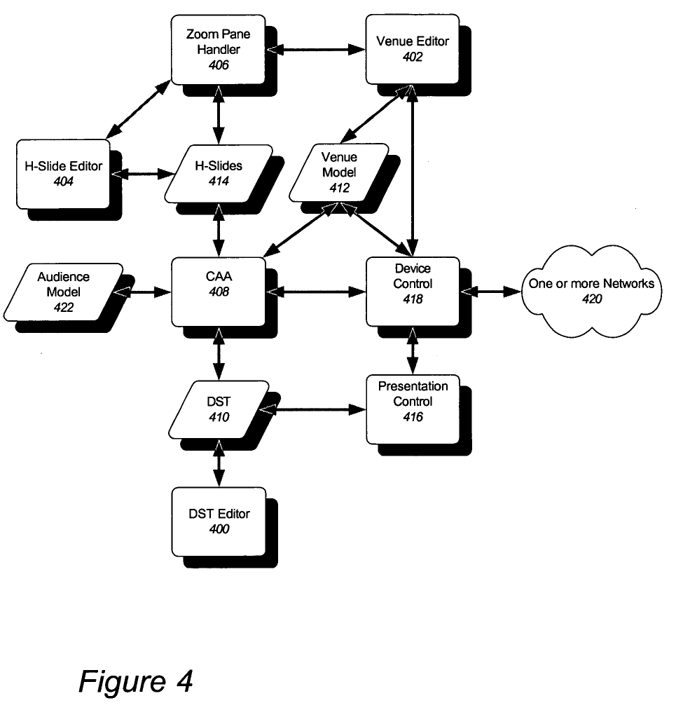

FIG. 4 is an illustration of a system in accordance to various embodiments. Although this diagram depicts components as logically separate, such depiction is merely for illustrative purposes. It will be apparent to those skilled in the art that the components portrayed in this figure can be combined or divided into separate software, firmware and/or hardware components. Furthermore, it will also be apparent to those skilled in the art that such components, regardless of how they are combined or divided, can execute on the same computing device or can be distributed among different computing devices connected by one or more networks or other suitable communication means.

In various embodiments, EPIC supports authoring and replaying synchronized presentation sequences for arbitrary combinations and placement of media devices. It is an upper-level tool that manages results of various single-channel media editors for a unified presentation with multiple devices. In aspects of these embodiments, each portion of the user interface 200 can be managed by a system component designed to handle specific events generated by a user interacting with the GUI. In this way, the GUI can be constructed in a manner that allows for easy reconfiguration with minimal impact on other components.

A venue editor component 402 is responsible for handling GUI events (e.g., select, copy, cut, paste, edit, delete, drag & drop, etc.) originating in the venue canvas and for rendering the output of a presentation (e.g., an augmented reality environment, a virtual environment, or the real environment) in the venue canvas with the aid of the device control component 418. The venue editor accesses a venue model 412 in order to render a depiction of the a venue in the venue canvas. An h-slide editor 404 can handle GUI events originating in the h-slide pane and allows the user to manage a collection of h-slides 414. In one embodiment, the h-slide editor renders a thumbnail representation in the h-slide pane for each h-slide in the collection.

A zoom pane handler 406 receives events from the h-slide pane editor to render a zoomed image of an h-slide for an h-slide that has been selected in the h-slide pane. In one embodiment, selection of a device portal in the venue canvas will cause the venue editor to notify the zoom pane handler to display the current device portal in the zoom pane of the GUI. By way of illustration, selection of a device portal that is a video camera will cause the camera output to be rendered in the zoom pane. Likewise, selecting a device portal that is a video display can cause the currently displayed image from the display to be rendered in the zoom pane.

A DST editor 400 can responds to GUI events originating in the DST pane and modifies the DST 410 accordingly. In one embodiment, copy, paste, insert, and delete of an h-slide in a DST are supported by the DST editor. By way of illustration, an h-slide thumbnail can be “dragged” from the h-slide pane and “dropped” on a device portal in the venue canvas. This will have the effect of creating a new state in the DST for displaying the h-slide on the media device upon which it was dropped. Alternatively, a user can drag an h-slide from the h-slide pane (or from a location in the DST), and drop it on a cell (e.g., a specific state and channel) in the DST. This will have the effect of either inserting a new state in the DST with the given h-slide and channel, or will cause the existing contents of the cell to be replaced with the new h-slide.

A device control 418 can send and receive information to devices which are available on one or more networks 420. In one embodiment, the presentation playback on multiple devices is achieved through network unicast performed by the device control under the direction of the presentation control 416. The presentation control uses the DST to send h-slides to specific channels via the device control. The device control maps channels into one or more specific media devices to which it sends h-slides. A remote agent is available on each media device (or on a computer to which a media device is connected). The agent listens on a pre-defined port for the unicast. Upon receiving an h-slide via the unicast, the agent causes the h-slide to be rendered on its corresponding media device. Broadcast channels, such as a notes-channel, can be implemented in one embodiment by placing h-slides associated with the channel available via Hypertext Transfer Protocol (HTTP) at channel-specific Uniform Resource Locators (URLs).

In one embodiment, the device control also can receive information from media devices (e.g., video streams, sound streams, etc.) and direct it to the venue editor. The venue editor in turn can display the information on the venue canvas. This allows a presenter to remotely monitor a presentation as it is underway. Depending on the venue configurations, various sensors, such as clocks and touch screens, may be utilized by the presenter to control the presentation progress.

With interfaces presented in the previous section, users still need to manually define which h-slide is rendered on each channel during each state of the presentation through manipulation of the DST table. In one embodiment, a Computer Authoring Assistant (CAA) 408 can reduce a user's authoring efforts by automatically assigning h-slides to channels for each state based on user-defined restriction rules (if any), a venue model 412, an audience distribution model 422, and the contents of the presentation. The audience distribution model includes the spatial distribution of audience members in the venue. The CAA automatically finds the ‘best’ mapping from h-slides to media devices for each state. This allows a user to take their presentation to any arbitrary venue without having to manually build or edit the DST.

In one embodiment, restriction rules can be used to explicitly assign channels or transitions for h-slides. By way of a non-limiting example, such restrictions can include rules such as: ‘current slide on primary-display’, ‘notes on audience PDA & Laptop displays’, ‘outline on left-display’, ‘display previous-slides,’ ‘h-slides on all-displays’, ‘three h-slides in every state’, ‘every slide on the primary display’, ‘left/right display shows contents’, ‘left display shows the previous slide of the primary display’, ‘left/right display shows the next slide of the primary display’, ‘left/right display shows the same content as the primary display’, etc. In one embodiment, the user may do some ‘fine tuning’ by overriding some of the automatic assignments. In another embodiment, the CAA is enabled to capture DST statistics for future reference in order to automatically determine restriction rules based on a user's preferences. These choices can be made automatically, but can also be modified by a user.

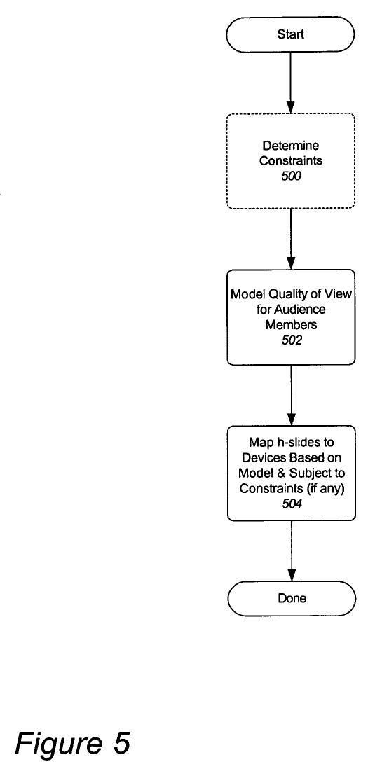

In one embodiment, the goal of presentation preparation is to let audience members perceive presentation materials as clearly as possible in a given venue. In various embodiments, the CAA models the quality of view available to audience members to find the best mapping from h-slides to devices, subject to constraints (if any). Although this discussion pertains to visual media, it will be apparent to those of skill in the art that a similar analysis could be provided for audio media. FIG. 5 is a flow chart illustrating computer authoring in accordance to various embodiments. Although this figure depicts functional steps in a particular order for purposes of illustration, the process is not necessarily limited to any particular order or arrangement of steps. One skilled in the art will appreciate that the various steps portrayed in this figure can be omitted, rearranged, performed in parallel, combined and/or adapted in various ways.

In step 500, it is determined whether or not any restriction rules apply. If so, the CAA can take them into account. In step 502, the quality of view available to audience members is modeled based on factors including (but not limited to) the distance between the audience member and the display upon which the h-slide is rendered, the display's size and resolution, and the signal transmitted by the display. In one embodiment, the goal is to minimize the distortion of the visual signal of a displayed h-slide from the perspective of an audience member. Based on this model, and subject to restriction rules (if any), h-slides from the h-slide collection 414 are assigned to media devices such that audience-perceived distortion of the displayed h-slide is minimized in step 504.

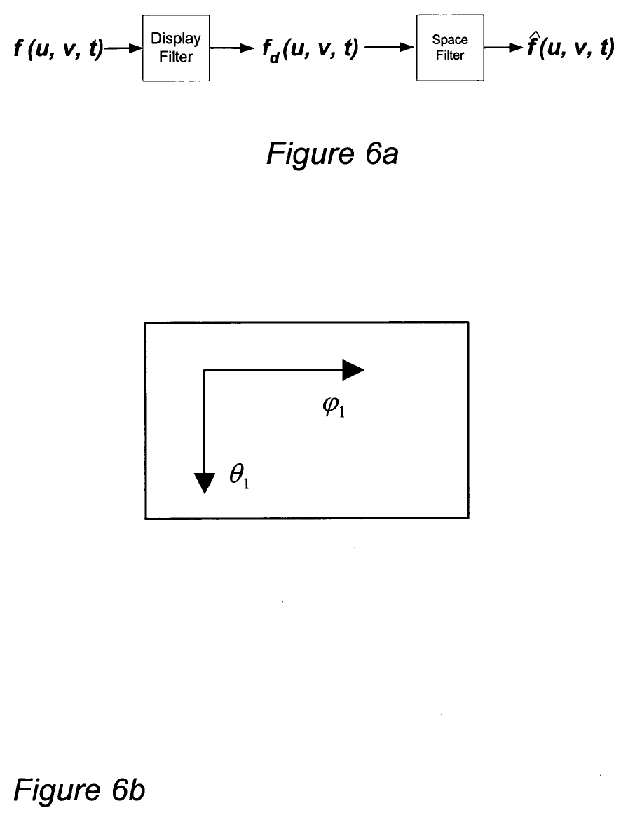

FIG. 6a is an illustration of a visual signal model for an audience member's view of a signal in accordance to various embodiments. By using u, v, and t to represent horizontal coordinates, vertical coordinates, and time respectively, an ideal signal, f(u,v,t) passes through a display filter 600 and a space filter 602 before it becomes \hat{f}(u,v,t) as perceived by an audience member. The display filter models the limited resolution of a display. In one embodiment, it can act as a band-limited filter whose horizontal cut-off frequency ωdₕ and vertical cut-off frequency ωdᵥ equal to one-half of the horizontal and vertical display resolutions respectively. The space filter is used to model the space relation between the audience member and a display patch, and the limited resolution of the audience member's eyes. In one embodiment, it can act as a band-pass filter whose cut-off frequency equal to one-half of the resolution of an audience member's eye. Conceptually, \hat{f}(u,v,t) may be thought of as the best reconstruction of the signal f(u,v,t) possible from a camera at the position of the audience member's eye, and with resolution comparable to the eye. In aspects of these embodiments, the cut-off frequency of a audience member's vision is assumed to be homogeneous in various direction. The spatial cut-off frequency is denoted by ωₛ and the temporal cut-off frequency is denoted by ωₜ.

In one embodiment, an audience member's location is considered as a point (x,y,z) in world Cartesian coordinates, and a point on a display has parameters (x₁,y₁,z₁,φ₁,θ₁,rₕ₁,rᵥ₁,rₜ₁), where (x₁,y₁,z₁) reflects the position of the point, (φ₁,θ₁) gives us the scan direction of the display like that shown in FIG. 6b, rₕ₁, rᵥ₁, and rₜ₁ are horizontal resolution, vertical resolution, and frame rate of the display respectively. Denoting X=(x,y,z)^{T}, the perception scaling factor, α, of a horizontal line may be approximated in one embodiment with:

$$α = \sqrt{1 - {[ \frac{( {X}_{1} - X ) \cdot {φ}_{1}}{\vert {X}_{1} - X \vert \cdot \vert {φ}_{1} \vert} ]}^{2}} / \vert {X}_{1} - X \vert$$

Similarly, the perception scaling factor, β, of a vertical line may be approximated in one embodiment with:

$$β = \sqrt{1 - {[ \frac{( {X}_{1} - X ) \cdot {θ}_{1}}{\vert {X}_{1} - X \vert \cdot \vert {θ}_{1} \vert} ]}^{2}} / \vert {X}_{1} - X \vert$$

By using F to represent signals in the spatial frequency domain and assuming displays and human eyes act as band limited filters, the signal relations in the model may be described in one embodiment with the following equations:

$${F}_{d} ( {ω}_{u} , {ω}_{v} , {ω}_{t} ) = \{ \begin{matrix}F ( {ω}_{u} , {ω}_{v} , {ω}_{t} ) & * \\ 0 & Otherwise\end{matrix} \\ * {ω}_{u} \leq \frac{{r}_{h1}}{2} , {ω}_{v} \leq \frac{{r}_{v1}}{2} , {ω}_{t} \leq \frac{{r}_{t1}}{2} \\ \hat{F} ( {ω}_{u} , {ω}_{v} , {ω}_{t} ) = \{ \begin{matrix}{F}_{d} ( {ω}_{u} , {ω}_{v} , {ω}_{t} ) & ** \\ 0 & Otherwise\end{matrix} \\ \begin{matrix}** {ω}_{u} \leq {αω}_{s} , & {ω}_{v} \leq {βω}_{s} & {ω}_{t} \leq {ω}_{st}\end{matrix}$$

With these equations in mind, the content distortion, D_{c}, of a perceived visual signal may be estimated in one embodiment with:

$${D}_{c} ∝ {\int \int \int }_{\begin{matrix}{ω}_{u} > min ( α \cdot {ω}_{s} , \frac{{r}_{h1}}{2} ) \\ {ω}_{v} > min ( β \cdot {ω}_{s} , \frac{{r}_{v1}}{2} ) \\ {ω}_{t} > min ( {ω}_{st} , \frac{{r}_{t1}}{2} ) \\ from t to t + T \end{matrix}} {\vert F ( {ω}_{u} , {ω}_{v} , {ω}_{t} ) \vert}^{2} ⅆ {ω}_{u} ⅆ {ω}_{v} ⅆ {ω}_{t} .$$

In one embodiment, D_{c} may be used to measure the visual distortion when a slide is correctly assigned to a display. When the CAA automates slide assignment, its choices may differ from the desired choices of the user. The corresponding ‘loss’ when a slide is incorrectly assigned to a media device can be modeled in one embodiment as:

$${D}_{inc} ∝ {\int \int \int }_{\begin{matrix}{ω}_{u} \geq 0 \\ {ω}_{v} \geq 0 \\ {ω}_{t} \geq 0 \\ Over T \end{matrix}} {\vert F ( {ω}_{u} , {ω}_{v} , {ω}_{t} ) \vert}^{2} ⅆ {ω}_{u} ⅆ {ω}_{v} ⅆ {ω}_{t} ,$$

where F is the spectra of the h-slide that was displayed incorrectly. Those of skill in the art will appreciate that there are many other ways to model distortion within the scope and spirit of the present disclosure.

In one embodiment, {Rᵢ} is a set of non-overlapping small regions on a display, T is a short time period, pₜ(Rᵢ|O) is the percentage of users viewing region-Rᵢ details, where O is a conditional state corresponding to context and possibly environmental observations. O can include features from text on a slide, the state of an h-slide, or textures within an image. The overall information loss of assigning a visual object to a display may be estimated in one embodiment as:

$$D = {\sum }_{i} \{ {p}_{t} ( {R}_{i} \vert O ) \cdot {D}_{c , i} + [ 1 - {p}_{t} ( {R}_{i} \vert O ) ] \cdot {D}_{inc , i} \}$$

In the above equation, it is assumed that the percentage of users viewing a region does not change during a relatively long period. This probability may be estimated in one embodiment with:

$${p}_{t} ( {R}_{i} \vert O ) = \{ \begin{matrix}0 & Against Guidance \\ \frac{{p}_{t} ( O \vert {R}_{i} ) \cdot {p}_{t} ( {R}_{i} )}{{p}_{t} ( O )} & Otherwise\end{matrix}$$

wherein the guidance to the system may be provided as restriction rules.

In one embodiment, the probability of satisfying an h-slide arrangement in a region and the probability of using a region may be estimated based on the system's past experience. Since a presenter's preferences regarding what makes a presentation good or bad can evolve over time, the above probability estimations can also adapt over time t to these changes. For example, if a particular presenter establishes a trend whereby the presenter always puts his notes on the left-most display, the CAA can take this into account so that future presentations will reflect the presenter's preference.

In one embodiment, the CAA strategy is to minimize the overall distortion D for each h-slide. Assume {Sᵢ} is a list of h-slides, {Deviceᵢ} is a list of media devices corresponding to the list {Sᵢ}. The optimal device assignment list {Deviceᵢ}ₒ may be described with:

$${\{ {Device}_{i} \}}_{o} = {arg min}_{\{ {Device}_{i} \}} ( D ) .$$

With this h-slide-device association strategy, EPIC can support a range of options from untended automatic to fully manual device-h-slide association. This strategy is also consistent with intuitions on what makes for good slide assignment. For example, we prefer using large, high resolution displays to show our slides; we prefer allocating large, high-resolution display for images that have more details; we prefer using displays closer to all audience members; we prefer giving users handouts when the display size and resolution is not enough for us to show details.

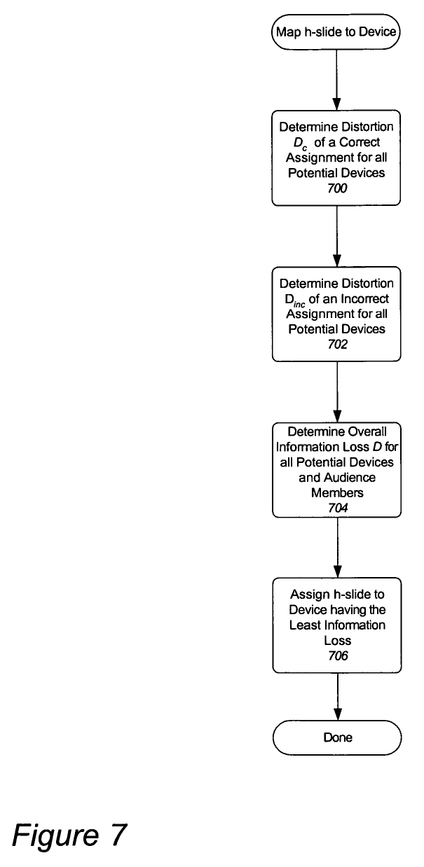

FIG. 7 is a flow chart illustrating selection of a media device for an h-slide in accordance to various embodiments. Although this figure depicts functional steps in a particular order for purposes of illustration, the process is not necessarily limited to any particular order or arrangement of steps. One skilled in the art will appreciate that the various steps portrayed in this figure can be omitted, rearranged, performed in parallel, combined and/or adapted in various ways.

In step 700, the distortion of a correct assignment D_{c} for a given h-slide is determined for each media device based on an audience distribution model. In step 702 the distortion of an incorrect assignment D_{inc} is also determined based on the same information for each media device. D_{c} and D_{inc} are then used to determine the overall information loss D for all potential devices and audience members in step 704. In step 706, the h-slide is assigned to the media device having the least amount of information loss (smallest D).

By way of illustration, if we do not limit the number of states for a presentation, and do not give the CAA any guidance for h-slide arrangement, the CAA may automatically show every slide on all displays for a better viewing result if, for example, the venue is a wide conference room having displays distributed on a wall facing the audience. This is consistent with the common practice performed in these kinds of rooms.

By way of another illustration, assume a venue has two displays (Display 1 and Display 2) facing the audience. Display 1 is a slide projector whose temporal cut-off frequency is close to 0 and Display 2 is a plasma display having a high temporal cut-off frequency. In this case, the CAA will automatically select Display 2 as the main display for video. Similarly, if Display 1 has higher resolution than Display 2, the system would prefer showing a static slide with Display 1. For other subtle users' preferences, the system may gradually learn them through online probability updates.

During elaborately constructed presentations, many presenters repeatedly remind audience members of the presentation context with a subtopic slide or an outline slide. If this type of reminding slides is presented too often in a presentation, it may waste an extensive amount of presentation time. Moreover, audience members may still forget context if they do not pay enough attention to the outline slide inserted in the main presentation stream. Finally, arranging all slides in one stream is inconvenient for using outline slides to navigate within a presentation.

All these problems can be easily tackled with multiple displays. For example, when two displays are available in a venue, a presenter can put a subtopic slide on a presenter-accessible display and a detailed presentation slide on another large display. With this arrangement, the presenter can provide presentation context to audience members by highlighting an ongoing subtopic. The presenter may also navigate the presentation through interacting with the subtopic display. Since the subtopic display is always on, the presenter may skip subtopic slides in the main presentation stream.

With multiple displays, supporting images/videos may be presented on a supporting display. By doing this, a presenter gets more choices to clarify a text statement on the major display, while closely related text statements can still be put on one slide without affecting the presentation's readability. The presenter also gets more choices to show clear multimedia data in a short period. In a different scenario, the presenter may consider setting a display as a whiteboard, composing surrounding sound for multiple loud speakers, or turning off some room lights.

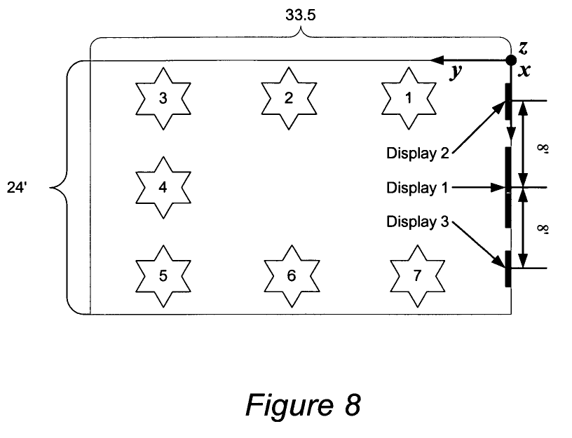

FIG. 8 is an illustration of an exemplary corporate conference room. The height of the conference room is 110 inches. A corner of the conference room is selected as the origin of our coordinate system. The z axis direction of the coordinate system is from the ground to the ceiling. There are three displays in the meeting room. Their ground-to-center heights are all 70 inches. Their refresh rates are 75 Hertz. The dimensions and installation heights of these displays are shown in Table 1. Based on display dimensions, resolutions, and simple geometry, we can easily derive display parameters shown in Table 2.

TABLE 1
Exemplary Display Dimensions and Installation Heights

| | DISPLAY 1 | DISPLAY 2 | DISPLAY 3 |
|---|---|---|---|
| Height (inches) | 72 | 25 | 25 |
| Width (inches) | 96 | 44 | 44 |
| Resolution | 1024 × 768 | 800 × 600 | 800 × 600 |

TABLE 2
Exemplary Display Parameters

| | DISPLAY 1 | DISPLAY 2 | DISPLAY 3 |
|---|---|---|---|
| x₁ (inches) | 96˜192 | 26˜70 | 218˜262 |
| y₁ (inches) | 0 | 0 | 0 |
| z₁ (inches) | 34˜106 | 57.5˜82.5 | 57.5˜82.5 |
| φ₁ (direction) | (1, 0, 0) | (1, 0, 0) | (1, 0, 0) |
| θ₁ (direction) | (0, 0, −1) | (0, 0, −1) | (0, 0, −1) |
| rₕ₁ (pixels/inch) | 10.667 | 18.18 | 18.18 |
| rᵥ₁ (pixels/inch) | 10.667 | 24 | 24 |

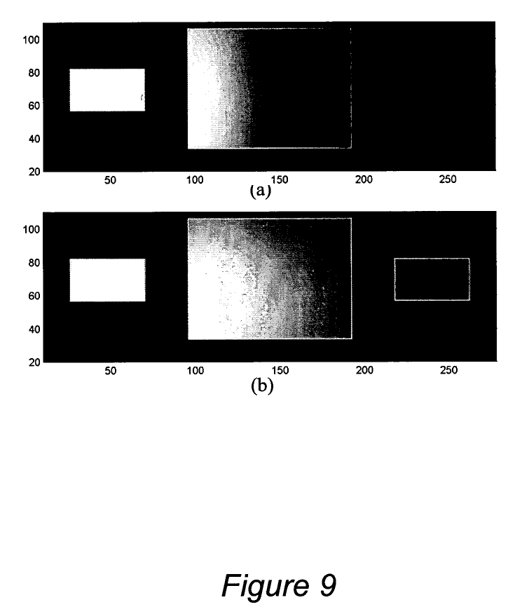

With these parameters, we may determine an audience member's perception scaling factors of a horizontal line or a vertical line when we know the person's eye location. In one embodiment, the following two assumptions are made: the average eye height of a person is 46.1 inches and the pixel size of a human's fovea may cover 0.31′ spatial angle. That is equivalent to ωₛ=96 cycles/degree. With these data, it is easy to compute α and β variations corresponding to various display portions. For an audience member sitting at location 1 (FIG. 8) with average eye height, α and β variations are shown in FIG. 9. From FIG. 9, it is apparent that visual distortion is more likely to be introduced in the horizontal direction for audience members in location 1.

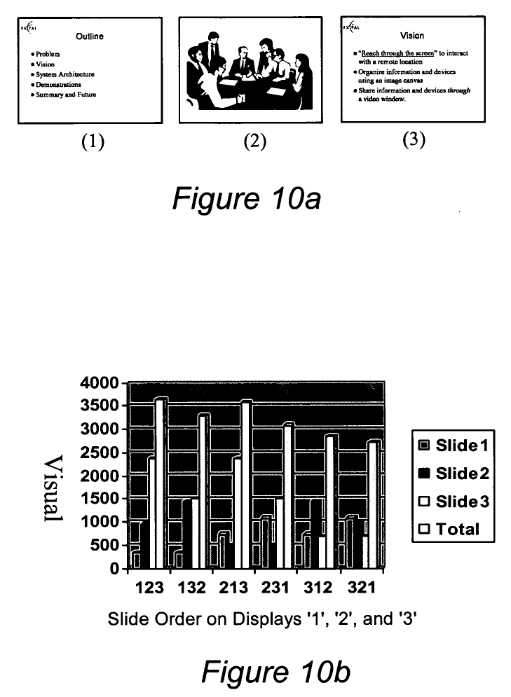

FIG. 10a shows three h-slides used in an exemplary presentation. The slides are numbered (1)-(3). Assuming the highest resolutions of these slides is 1280×960, and all probability distributions in the system are uniform distributions, the computed distortions of various slide arrangements for the audience member at location 1 are shown in FIG. 10b. Information loss D is shown on the y-axis and h-slide order is shown on the x-axis. Based on these data, it is straightforward to determine the minimum distortion arrangement.

Since the exemplary conference room of FIG. 8 has three displays available, showing a subtopic h-slide on a side display is a good starting point. In one embodiment, the system can characterize h-slides as subtopics if they contain titles such as ‘subtopic’, ‘contents‘, or ‘outline’, etc. When a subtopic h-slide is not available, the system can automatically generate one based on titles of other h-slides. If an h-slide is a media file without a title, the software will use ‘media support’ to fill the corresponding location on a subtopic h-slide.

In one embodiment and by way of illustration, to make the auto arrangement reasonable from the beginning the system can be initialized with the following parameters:
p(on display2|subtopic h-slide)=1
p(on display3|prev display=display1)=1

Besides these two probabilities, all other probability functions can be initialized as uniform distributions. The effect of this initialization is to automatically put a subtopic h-slide on display 2, put current h-slide on display 1, and put previous h-slide on display 3.

Various embodiments may be implemented using a conventional general purpose or specialized digital computer(s) and/or processor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits and/or by interconnecting an appropriate network of conventional component circuits, as will be readily apparent to those skilled in the art.

Various embodiments include a computer program product which is a storage medium (media) having instructions stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, microdrives, magneto-optical disks, holographic storage, ROMs, RAMs, PRAMS, EPROMs, EEPROMs, DRAMs, VRAMs, flash memory devices, magnetic or optical cards, nanosystems (including molecular memory ICs); paper or paper-based media; and any type of media or device suitable for storing instructions and/or information. Various embodiments include a computer program product that can be transmitted in whole or in parts and over one or more public and/or private networks wherein the transmission includes instructions which can be used by one or more processors to perform any of the features presented herein. In various embodiments, the transmission may include a plurality of separate transmissions.

Stored one or more of the computer readable medium (media), the present disclosure includes software for controlling both the hardware of general purpose/specialized computer(s) and/or processor(s), and for enabling the computer(s) and/or processor(s) to interact with a human user or other mechanism utilizing the results of the present invention. Such software may include, but is not limited to, device drivers, operating systems, execution environments/containers, user interfaces and applications.

The foregoing description of the preferred embodiments of the present invention has been provided for purposes of illustration and description. It is not intended to be exhaustive or to limit the invention to the precise forms disclosed. Many modifications and variations will be apparent to the practitioner skilled in the art. Embodiments were chosen and described in order to best explain the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A method for optimizing the visual fidelity of a presentation for a plurality of audience members and a plurality of display devices, comprising:
modeling the quality of view available to the plurality of audience members based on:
one or more properties of the display devices,
a distribution of the display devices,
a distribution of the plurality of audience members, and
the visual presentation wherein the visual presentation comprises one or more h-slides; and
determining an optimal mapping for the one or more h-slides to the plurality of display devices based on the modeling.

2. The method of claim 1 wherein:
the determination of the optimal mapping minimizes information loss from the perspective of the audience members.

3. The method of claim 1 wherein:
the determining is subject to one or more restrictions based on the preferences of a presenter.

4. The method of claim 1, further comprising:
providing restrictions by automatically learning the preferences of the presenter.

5. The method of claim 1 wherein the step of modeling further comprises:
determining the content distortion for the plurality of display devices for each h-slide.

6. The method of claim 1 wherein the step of modeling further comprises:
determining the content loss for the plurality of display devices.

7. The method of claim 1 wherein:
an h-slide is one of: an input source, a control action, and an object that can be rendered by one or more of the plurality of display devices.

8. The method of claim 1 wherein:
the determining of the optimal mapping associates an h-slide with at least one of the plurality of display devices at a point in time.

9. A system for optimizing the visual fidelity of a presentation for a plurality of audience members and a plurality of display devices, comprising:
a venue model including a plurality of display devices;
a computer authoring assistant capable of determining an optimal mapping for the one or more h-slides to the plurality of display devices wherein the presentation includes the one or more h-slides; and
a presentation control capable of running the presentation based on the optimal mapping.

10. The system of claim 9 wherein:
the computer authoring assistant determines the optimal mapping based on an audience distribution model, one or more properties of the plurality of display devices; and the presentation.

11. The system of claim 9, further comprising:
a device control coupled to the presentation control and capable of communicating with the plurality of display devices.

12. The system of claim 9, further comprising:
a graphical user interface.

13. The system of claim 12, wherein the graphical user interface further comprises:
a first graphical user interface capable of showing the presentation in at least one of: a virtual environment, an augmented reality environment, and a real environment.

14. The system of claim 12, wherein the graphical user interface further comprises:
a first graphical user interface capable of allowing a presenter to make changes to a presentation on an ad-hoc basis.

15. The system of claim 12, wherein:
the computer authoring assistant can learn the presentation preferences of a presenter.

16. A program of instructions executable by a computer to perform a function for optimizing the visual fidelity of a presentation for a plurality of audience members and a plurality of display devices, comprising the steps of:
modeling the quality of view available to the plurality of audience members based on:
one or more properties of the display devices,
a distribution of the display devices,
a distribution of the plurality of audience members, and
the visual presentation wherein the visual presentation comprises one or more h-slides; and
determining an optimal mapping for the one or more h-slides to the plurality of display devices based on the modeling.

17. The program of claim 16 wherein:
the determination of the optimal mapping minimizes information loss from the perspective of the audience members.

18. The program of claim 16 wherein:
the determining is subject to one or more restrictions based on the preferences of a presenter.

19. The program of claim 16. further comprising:
providing restrictions by automatically learning the preferences of the presenter.

20. The program of claim 16 wherein the step of modeling further comprises:
determining the content distortion for the plurality of display devices for each h-slide.

21. The program of claim 16 wherein the step of modeling further comprises:
determining the content loss for the plurality of display devices.

22. The program of claim 16 wherein:
an h-slide is one of: an input source, a control action, and an object that can be rendered by one or more of the plurality of display devices.

23. The program of claim 16 wherein:
the determining of the optimal mapping associates an h-slide with at least one of the plurality of display devices at a point in time.
